(19) United States
(12) Patent Application Publication
(10) Pub. No.: US 2026/0058856 A1
(43) Pub. Date: Feb. 26, 2026

(54) LOW PAPR DMRS FOR OFDM

(71) Applicant: QUALCOMM Incorporated, San Diego, CA (US)

(72) Inventors: Igor GUTMAN, Hod HaSharon (IL); Tao LUO, San Diego, CA (US); Ori SHENTAL, Marlboro, NJ (US); Jing JIANG, San Diego, CA (US)

(21) Appl. No.: 19/103,203

(22) PCT Filed: Sep. 18, 2023
(86) PCT No.: PCT/US2023/033081

§ 371 Date: Feb. 11, 2025

(30) Foreign Application Priority Data
Sep. 23, 2022 (IL) 296795

(51) Int. Cl. H04L 27/26; H04W 72/21; H04W 72/231

(52) U.S. Cl. CPC H04L 27/2623; H04L 27/2613; H04W 72/21; H04W 72/231

(57) ABSTRACT

Apparatus, methods, and computer program products for processing reference signals are provided. An example method may include receiving or transmitting an indication associated with support of a first reference signal sequence, where the first reference signal is based on a second reference signal sequence via a digital iterative clipping and filtering (ICF) process. The example method may further include communicating with a second network entity based on a set of reference signals, where the first reference signal sequence includes the set of reference signals.

### CROSS-REFERENCE TO RELATED APPLICATION

This application claims the benefit of Israel Patent Application Serial No. 296795, entitled “LOW PAPR DMRS FOR OFDM” and filed on Sep. 23, 2022, which is expressly incorporated by reference herein in its entirety.

### TECHNICAL FIELD

The present disclosure relates generally to communication systems, and more particularly, to wireless communication systems with demodulation reference signal (DMRS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity (e.g., a user equipment (UE) or a base station) are provided. The apparatus may include a memory and at least one processor coupled to the memory. The at least one processor may be configured to receive or transmit an indication associated with support of a first reference signal sequence, where the first reference signal is based on a second reference signal sequence via a digital ICF process. The at least one processor may be configured to communicate with a second network entity based on a set of reference signals, where the first reference signal sequence includes the set of reference signals.

In another aspect of the disclosure, a method, a computer-readable medium, and an apparatus at a first network entity (e.g., a user equipment (UE) or a base station) are provided. The apparatus may include a memory and at least one processor coupled to the memory. The at least one processor may be configured to perform ICF on a first reference signal sequence to generate a second reference signal sequence. The at least one processor may be configured to communicate with a second network entity based on a set of reference signals, where the second reference signal sequence includes the set of reference signals.

In another aspect of the disclosure, a method, a computer-readable medium, and an apparatus at a first network entity (e.g., a user equipment (UE) or a base station) are provided. The apparatus may include a memory and at least one processor coupled to the memory. The memory may have a first reference signal sequence and a second reference sequence signal stored thereon, where the second reference signal is based on the first reference signal sequence via a digital process. The at least one processor may be configured to communicate with a second network entity based on a set of reference signals, where the second reference signal sequence includes the set of reference signals.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of slots for physical downlink shared channel (PDSCH) and DMRS symbols.

FIG. 5 is a diagram illustrating an example of distortion of a PDSCH and DMRS.

FIG. 6 is a diagram illustrating an example of a scatter plot of DMRS.

FIG. 7 is a diagram illustrating example communications between a network entity and a UE.

FIG. 8 is a diagram illustrating an example of comparison of DMRS sequence based on digital iterative clipping and filtering (ICF) and DMRS sequence without digital ICF.

FIG. 9 is a diagram illustrating an example of peak-to-average-power ratio (PAPR) of a DMRS.

FIG. 10 is a diagram illustrating an example of PAPR with different constraint thresholds.

FIG. 11A is a diagram illustrating an example of a scatter plot of DMRS.

FIG. 11B is a diagram illustrating an example of a scatter plot of DMRS.

FIG. 11C is a diagram illustrating an example of a scatter plot of DMRS.

FIG. 12A is a diagram illustrating an example of a scatter plot of DMRS.

FIG. 12B is a diagram illustrating an example of a scatter plot of DMRS.

FIG. 13 is a flowchart of a method of wireless communication.

FIG. 14 is a flowchart of a method of wireless communication.

FIG. 15A is a flowchart of a method of wireless communication.

FIG. 15B is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, ma be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

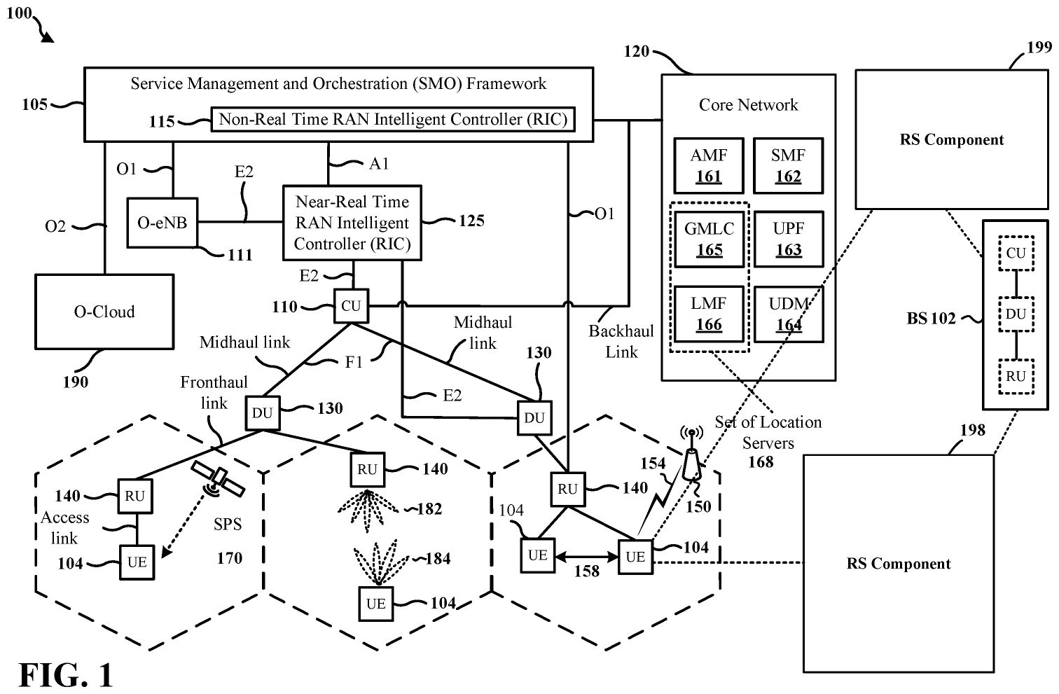

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 or the base station 102 may include a RS component 198. In some aspects, the RS component 198 may be configured to receive or transmit an indication associated with support of a first reference signal sequence, where the first reference signal is based on a second reference signal sequence via a digital ICF process. In some aspects, the RS component 198 may be further configured to communicate with a second network entity based on a set of reference signals, where the first reference signal sequence includes the set of reference signals.

In certain aspects, the base station 102 or the UE 104 may include a RS component 199. In some aspects, the RS component 199 may be configured to perform ICF process on a first reference signal sequence to generate a second reference signal sequence. In some aspects, the RS component 199 may be further configured to communicate with a second network entity based on a set of reference signals, where the second reference signal sequence includes the set of reference signals.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU)(which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

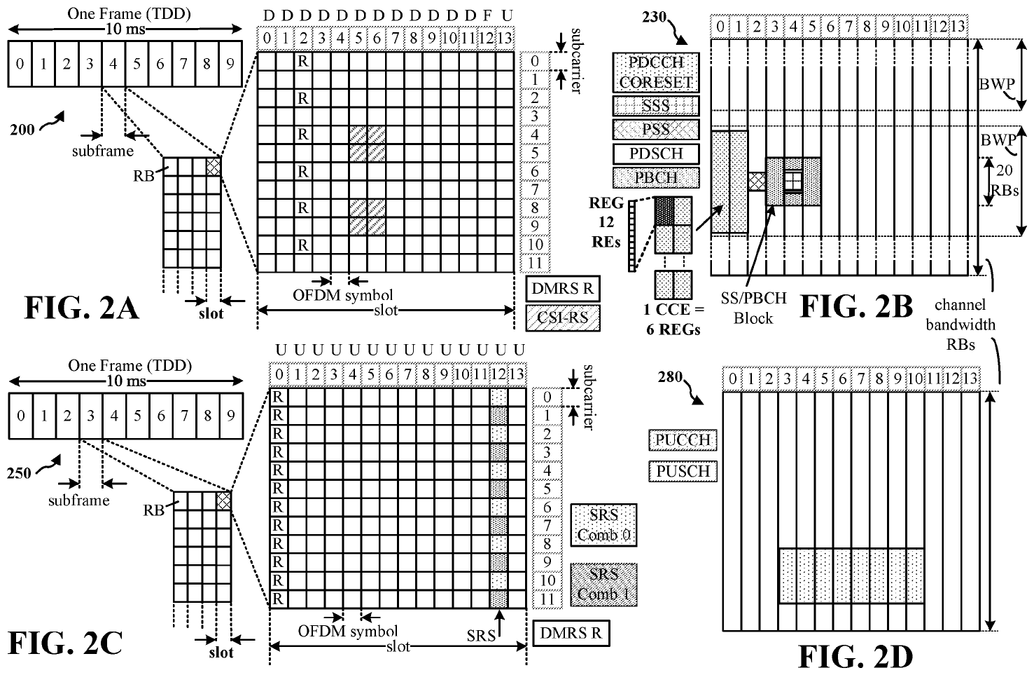

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS)(indicated as R for one particular configuration, but other DMRS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DMRS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DMRS (indicated as R for one particular configuration, but other DMRS configurations are possible) for channel estimation at the base station. The UE may transmit DMRS for the physical uplink control channel (PUCCH) and DMRS for the physical uplink shared channel (PUSCH). The PUSCH DMRS may be transmitted in the first one or two symbols of the PUSCH. The PUCCH DMRS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

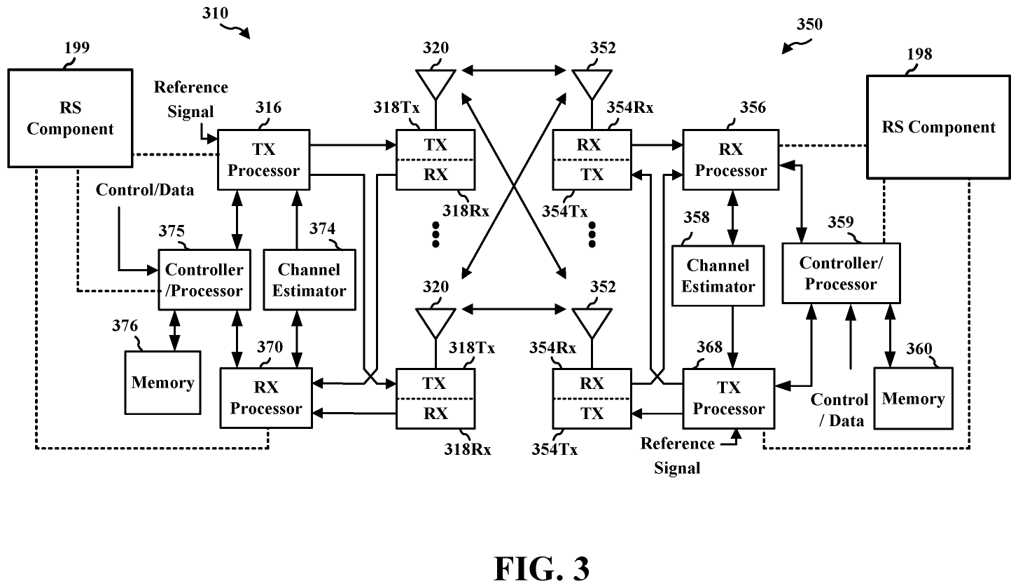

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with RS component 198 or RS component 199 of FIG. 1.

At least one of the TX processor 316, the RX processor 370, and the controller/processor 375 may be configured to perform aspects in connection with RS component 199 or RS component 198 of FIG. 1.

A transmitter at a UE or a base station of a wireless communication system may include non-linear components, such as high-power amplifiers (PA) with limited linear dynamic range (DR) and polynomial response. Such non-linear components may have a high PAPR and may distort a transmitted signal due to the high PAPR Distortions caused by the non-linear components may be classified as: (1) in-band distortion, which may affect link performance in error vector magnitude (EVM), or (2) out-band distortion, which may affect an amount of adjacent channel interference. To avoid the distortions, power output back-off may be introduced. Power output back-off may be a power level at the output of RF amplifier (e.g., of a transceiver) relative to maximum output level possible using the RF amplifier. With power output back-off, the maximum power that of the output may be reduced compared to the maximum output level possible. However, with more power output back-off, the power added efficiency (PAE) may decrease, which may cause less power being transmitted to the channel while more power may be dissipated as heat. Aspects provided herein may enable reducing PAPR for transmission of reference signals (RS) (e.g., DMRS) by modifying a sequence (e.g., complex magnitude information of a sequence). Both a transmitting entity and a receiving entity of the RS may be aware of the reduced PAPR Also, the reduced PAPR may not affect any properties of the RS (out of band (OOB) and orthogonality). As used herein, the term “RS sequence” may refer to complex magnitude information for processing a RS for transmission or reception. As used herein, the term “digital ICF” or “digital ICF process” may refer to a process of iteratively clipping and filtering a digital sequence for a signal (e.g., until a PAPR target is reached).

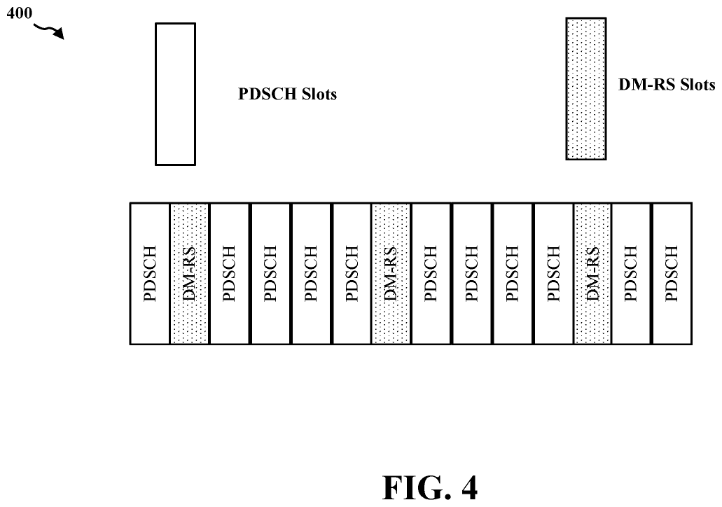

FIG. 4 is a diagram 400 illustrating an example of slots for PDSCH and DMRS symbols. As illustrated in FIG. 4, a series of slots may include three example DMRS slots spread among eleven example PDSCH slots. Each DMRS slot may be followed by four PDSCH slots. The DMRS slots may be carrying DMRS used for channel estimation. The channel estimation may be used for PDSCH demodulation associated with the PDSCH slots. As an example, power amplifier back-off (PA BO) may be used for both the PDSCH slots or the DMRS slots in a similar manner. If a PA BO is used for the DMRS slots and reduced for the PDSCH slots, a signal-to-interference plus noise ratio (SINR) on the PDSCH may be smaller and demodulation performance may be affected. If a PA BO is used for the PDSCH slots and reduced for the DMRS slots, SINR on the DMRS may be smaller and performance of the channel estimation may be reduced, which may also affect the demodulation performance.

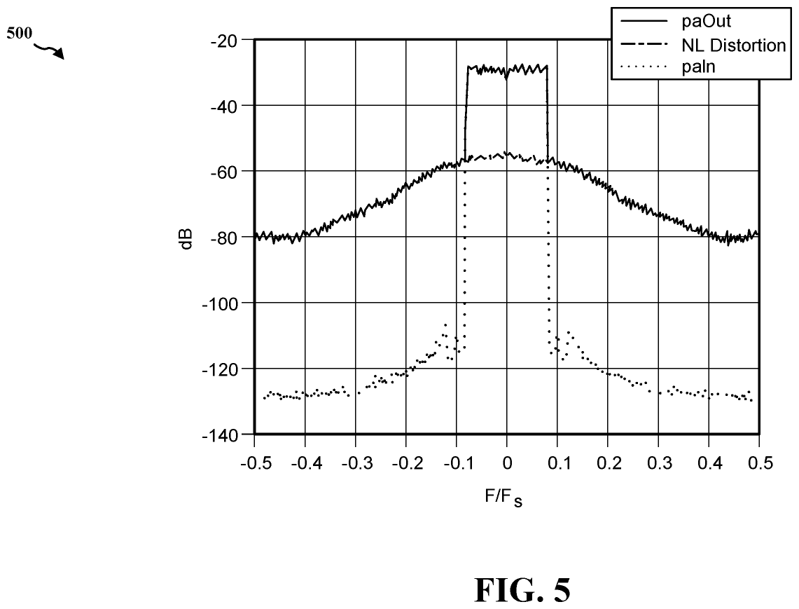

FIG. 5 is a diagram 500 illustrating an example of non-linear (NL) distortion for both PDSCH and DMRS. The vertical axis may represent decibels (dB) and the horizontal axis may represent time in a full scale.

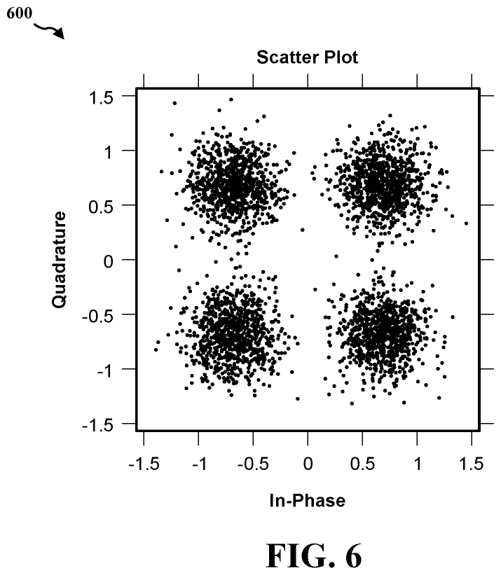

FIG. 6 is a diagram 600 illustrating an example of a scatter plot of DMRS sequence. The horizontal axis may represent an in-phase component of the DMRS sequence and the vertical axis may represent a quadrature component of the DMRS sequence. The in-phase component and the quadrature component may have a same frequency and may be out of phase by 90 degrees. In some aspects, the DMRS sequence may be processed by applying digital ICF on the DMRS sequence such that a modified DMRS (which may be referred to as “MDMRS”) sequence may be generated. The digital ICF may include a clip component.

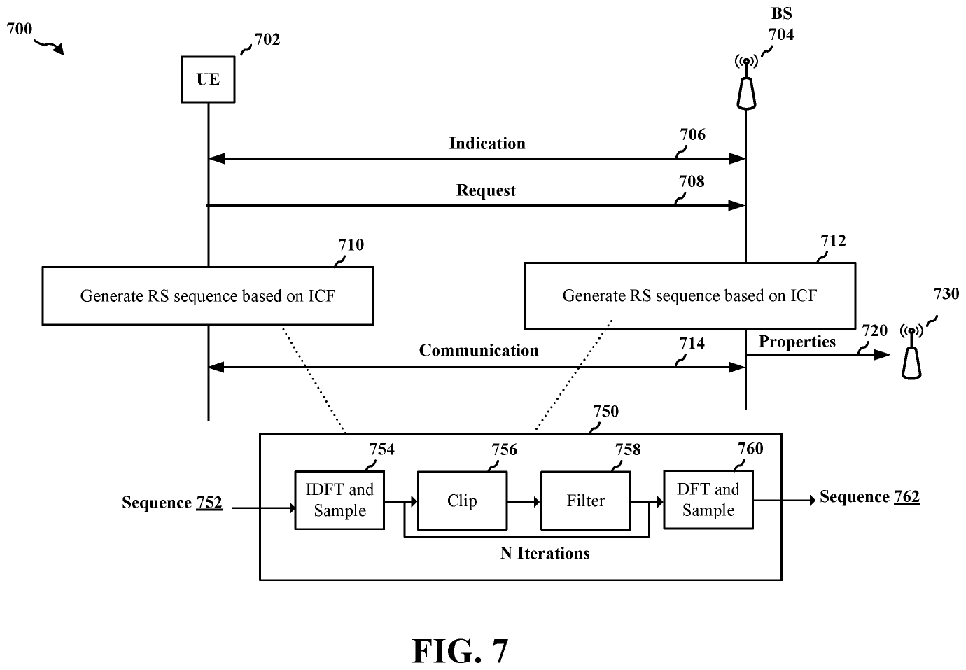

FIG. 7 is a diagram 700 illustrating example communications between a network entity 704 (such as a base station) and a UE 702. As illustrated in FIG. 7, at 710 or 712, the UE 702 or the network entity 704 may generate an RS sequence based on ICF on another RS sequence based on a RS sequence generation process 750. For example, a sequence 752 (e.g., complex magnitude information of the sequence) may be processed based on inverse discrete Fourier transform (IDFT) and down sample at 754. The result of the IDFT and the down sample at 754 may be processed based on clipping at 756. The clipping may be a soft limiter with a PAPR target as parameter. After the clipping at 756, the result may be processed by a filter 758, which may be a low pass filter (LPF)(e.g., a configured LPF with a bandwidth equal to the sequence's bandwidth). The clipping at 756 and the filtering at 758 may be applied N times, where N is a positive integer. In some aspects, the result of the filter 758 may be processed based on discrete Fourier transform (DFT) and sample at 760 to generate a sequence 762.

In some aspects, the sequence 752 and the sequence 762 may be DMRS sequences. In some aspects, the sequence 752 and the sequence 762 may be sounding reference signal (SRS) sequences. In some aspects, the sequence 752 and the sequence 762 may be tracking reference signal (TRS) sequences. In some aspects, the sequence 752 and the sequence 762 may be phase tracking signal (PTRS) sequences. In some aspects, the sequence 752 and the sequence 762 may be CSI-RS sequences. In some aspects, the sequence 752 and the sequence 762 may be any periodic RS sequences that may be a pilot (pilot signal for supervisory, control, equalization, continuity, synchronization, reference, or the like) and with a constant periodicity over an entire bandwidth. In some aspects, the sequence 762 may include orthogonal pilots and the LPF may keep OOB to be clean.

In some aspects, the UE 702 may indicate (e.g., via radio resource control (RRC) signaling, a medium access control (MAC) control element (MAC-CE), UCI, or the like) whether the UE 702 supports usage of RSs processed based on a digital ICF (e.g., processed based on 750) in an indication 706 to the network entity 704. In some aspects, the network entity 704 may indicate (e.g., via RRC signaling, a MAC-CE, DCI, or the like) whether the network entity 704 supports usage of RSs processed based on a digital ICF (e.g., processed based on 750) in an indication 706 to the UE 702. In some aspects, the indication 706 may represent that usage of RSs processed based on a digital ICF may be supported or used for downlink (e.g., in Rx at the UE 702 and Tx at the network entity 704). In some aspects, the indication 706 may represent that usage of RSs processed based on a digital ICF may be supported or used for uplink transmissions (e.g., in Tx at the UE 702 and Rx at the network entity 704).

In some aspects, the indication 706 may include one or more ranges of support (which may also be referred to as span of support) associated with an LPF coefficient, a quantity of iterations, a PAPR target, an upscaling sampling factor or a downscaling sampling factor, a boosting compared with the original sequence, or a constraint threshold. In some aspects, the UE 702 may also transmit a request 708 for values of an LPF coefficient, a quantity of iterations, a PAPR target, an upscaling sampling factor or a downscaling sampling factor, a boosting compared with the original sequence, or a constraint threshold. In some aspects, the request 708 may include the values and may represent that the UE 702 may use the LPF coefficient, the quantity of iterations, the PAPR target, the upscaling sampling factor or the downscaling sampling factor, the boosting compared with the original sequence, or the constraint threshold for the digital ICF based on the values (e.g., the network entity 704 may approve the values included in the request). In some aspects, the request 708 may not include values and the network entity 704 may transmit the values of the LPF coefficient, the quantity of iterations, the PAPR target, the upscaling sampling factor or the downscaling sampling factor, the boosting compared with the original sequence, or the constraint threshold for the digital ICF for the UE 702 to use.

After the sequence 762 is generated, such a RS may be used by the UE 702 or the network entity 704 and transmitted accordingly in communication 714. A receiving end (another one of the UE 702 or the network entity 704) of the communication 714 may apply a same processing of ICF at 750 and may use the RS for a variety of purpose, such as time and frequency tracking or channel estimation.

In some aspects, the generation at 710 and 712 may be performed upon transmission of a RS. In such aspects, the generation at 710 and 712 may be performed in real time for the communication 714 (e.g., without storing the second reference signal sequence in a memory that stores data when there is no power present). In some aspects, the generation at 710 and 712 may be performed before transmission of RS and stored in a memory of the UE 702 or the network entity 704, such that the generated sequences may be used once a RS may be transmitted. For example, the UE 702 or the network entity 704 may generate and store a set of different sequences at 710 and 712, and one sequence may be used upon transmission/reception of the RS. In some aspects, the generation at 710 and 712 may be performed without the indication 706 and the generated sequences may be used without the indication 706. For example, the UE 702 or the network entity 704 may use one sequence generated at 710 or 712 to transmit and receive a RS. In some aspects, one or more properties 720 (such as PAPR property, frequency shift, Doppler spread, delay spread, or other information regarding RS) of the RS may be transmitted to a neighbor cell 730 to enable estimation of inter-cell interference at the neighbor cell.

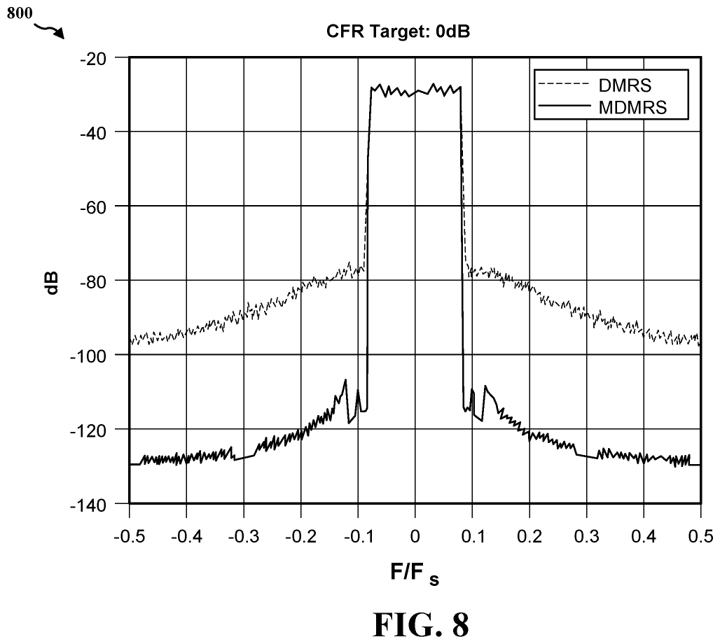

FIG. 8 is a diagram 800 illustrating an example of comparison of DMRS sequence based on ICF and DMRS sequence without digital ICF. As illustrated in FIG. 8, crest factor reduction (CRF) target (crest factor may be a parameter representing the ratio of peak values to the effective value) may be 0 dB. The DMRS sequence and the MDMRS sequence may be associated with a same spectral mask for PAPR target (which may correspond to the CRF target) of 0 dB.

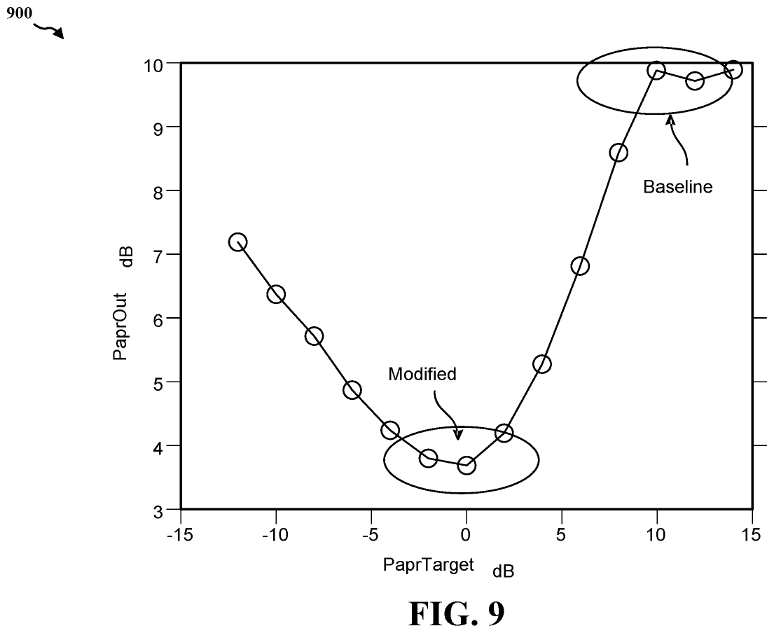

Referring to FIG. 9, FIG. 9 is a diagram 900 illustrating an example of PAPR of a DMRS. As illustrated in FIG. 9, the PAPR of a DMRS sequence without digital ICF (about 10 dB) may be much higher than the PAPR of the DMRS sequence after applying digital ICF (about 3.6 dB), which may result in a power boost of more than 6 DB in a DMRS transmission, which may positively affect the SINR

An output of the ICF may be further processed based on a constraint on an energy, such as based on:

$$Signal ( {P}_{signal} < - t h {r}_{db} ) = {e}^{i \cdot ∠ Signal ( {P}_{Signal} < - t h {r}_{db} )} \cdot {10}^{\frac{- {thr}_{db}}{20}} .$$

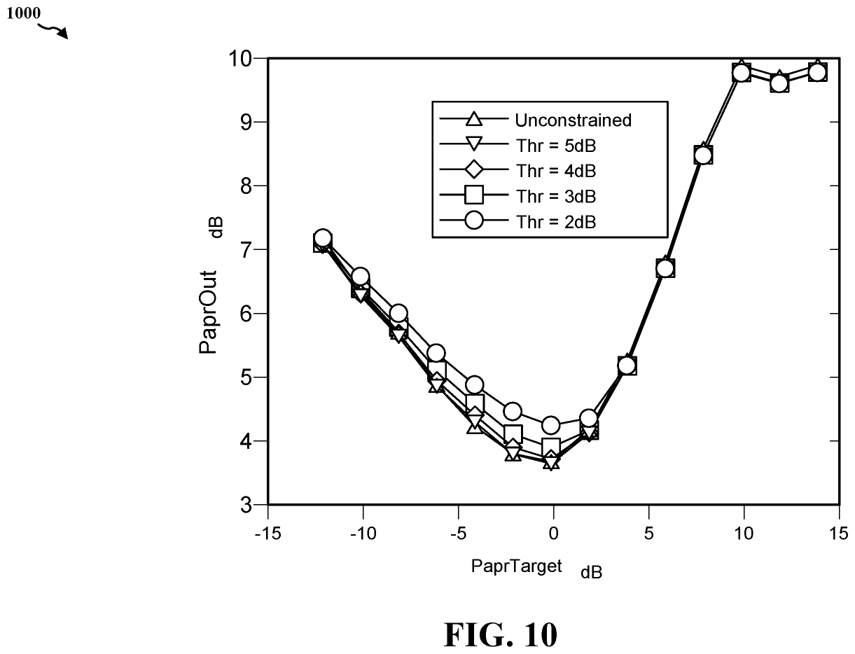

The parameter P_{signal} may represent power of the output of the ICF, the parameter thr_{db} may represent a constraint threshold in dB. FIG. 10 is a diagram 1000 illustrating an example of PAPR with different constraint thresholds. As illustrated in FIG. 10, PAPR of the output may be different for different constraint thresholds.

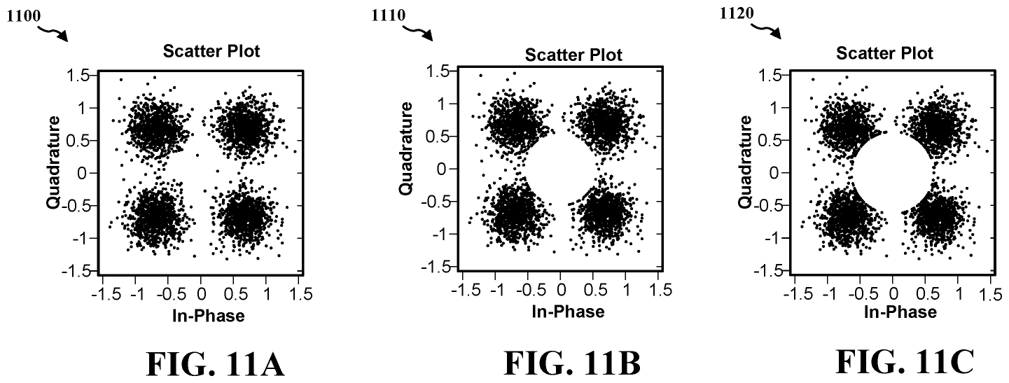

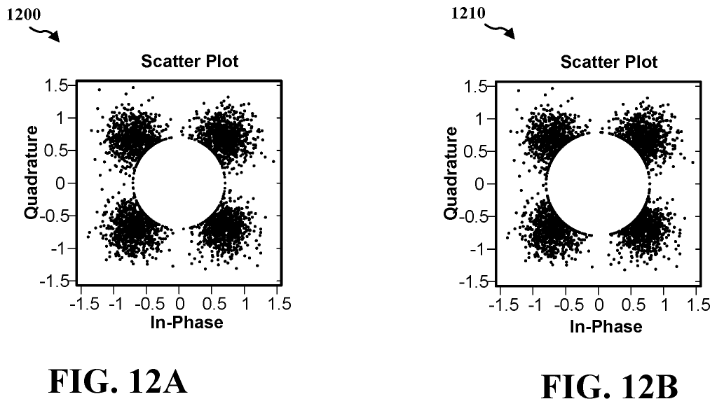

FIG. 11A is a diagram 1100 illustrating an example of a scatter plot of DMRS. In FIG. 11A, N (N being the number of iterations) may be a first value. FIG. 11B is a diagram 1110 illustrating an example of a scatter plot of DMRS. In FIG. 11B, N may be a second value. FIG. 11C is a diagram 1120 illustrating an example of a scatter plot of DMRS. In FIG. 11C, N may be a third value. FIG. 12A is a diagram 1200 illustrating an example of a scatter plot of DMRS. In FIG. 12A, N may be a fourth value. FIG. 12B is a diagram 1210 illustrating an example of a scatter plot of DMRS. In FIG. 12B, N may be a fourth value.

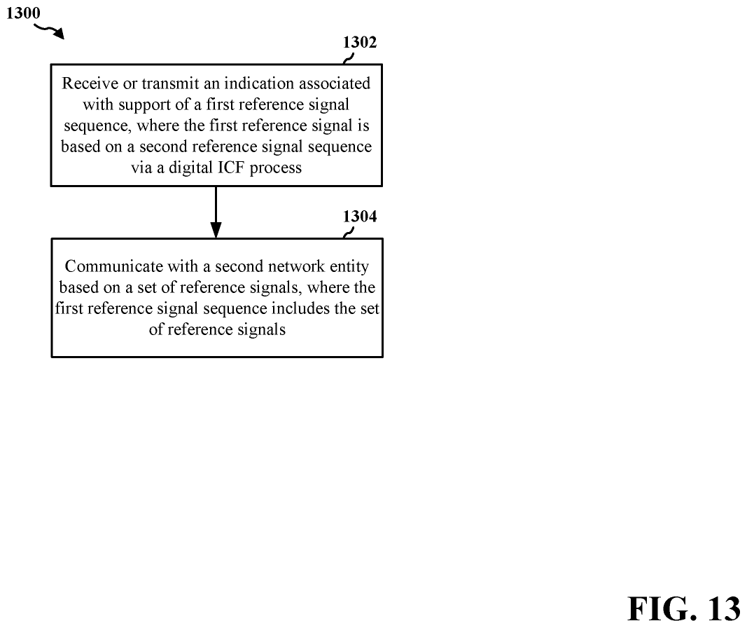

FIG. 13 is a flowchart 1300 of a method of wireless communication. The method may be performed by a first network entity (e.g., the UE 104, the base station 102, the UE 702, the network entity 704, the apparatus 1604, the network entity 1602, the network entity 1702).

At 1302, the first network entity may receive or transmit an indication associated with support of (e.g., capability of supporting) a first reference signal sequence, where the first reference signal is based on a second reference signal sequence via a digital ICF process. For example, the first network entity (e.g., the UE 702 or the network entity 704) may receive or transmit an indication 706 associated with support of a first reference signal sequence, where the first reference signal is based on a second reference signal sequence via a digital ICF process. In some aspects, 1302 may be performed by RS component 198. In some aspects, the digital ICF process may include a low-pass filter, and where a first bandwidth associated with the low-pass filter may be equal to a second bandwidth associated with the second reference signal sequence. In some aspects, the digital ICF process may include a clip associated with a PAPR target. In some aspects, the indication may include one or more low pass filter (LPF) coefficient information associated with the digital ICF process (e.g., supported LPF coefficients, supported range of LPF coefficient, or a LPF coefficient representing LPF coefficient that the first network entity would use), quantity of iterations information associated with the ICF process (e.g., supported quantity of iterations, supported range of quantity of iteration, or a quantity of iterations representing quantity of iterations that the first network entity would use), PAPR target information associated with the ICF process (e.g., supported PAPR target, supported range of PAPR target, or a PAPR target representing PAPR target that the first network entity would use), upscaling sampling factor information associated with the ICF process (e.g., supported upscaling sampling factor, supported range of upscaling sampling factor, or a upscaling sampling factor representing upscaling sampling factor that the first network entity would use), downscaling sampling factor information associated with the ICF process (e.g., supported downscaling sampling factor, supported range of downscaling sampling factor, or a downscaling sampling factor representing downscaling sampling factor that the first network entity would use), information regarding difference in PAPR between the first reference signal sequence and the second reference signal sequence associated with the ICF process (e.g., supported PAPR difference, supported range of PAPR difference, or a PAPR difference representing PAPR difference that the first network entity would use), or energy constraint threshold information associated with the ICF process (e.g., supported energy constraint threshold, supported range of energy constraint threshold, or an energy constraint representing energy constraint that the first network entity would use). In some aspects, the first network entity may transmit the indication to the second network entity via RRC signaling, DCI or UCI, or MAC-CE. In some aspects, the indication may be associated with an uplink transmission from the first network entity to the second network entity, a downlink transmission from the first network entity to the second network entity, a downlink transmission from the second network entity to the first network entity, or an uplink transmission from the second network entity to the first network entity. In some aspects, the first network entity may also transmit, to the second network entity via the RRC signaling, DCI or UCI, or MAC-CE, one or more of: a LPF coefficient associated with the ICF process, a quantity of iterations associated with the ICF process, a PAPR target associated with the ICF process, a upscaling sampling factor associated with the ICF process or a downscaling sampling factor associated with the ICF process, a difference in PAPR between the first reference signal sequence and the second reference signal sequence, or an energy constraint threshold associated with the ICF process.

At 1304, the first network entity may communicate with a second network entity based on a set of reference signals, where the first reference signal sequence includes the set of reference signals. For example, the first network entity (e.g., the UE 702 or the network entity 704) may communicate with a second network entity (e.g., 714) based on a set of reference signals, where the first reference signal sequence includes the set of reference signals. In some aspects, 1302 may be performed by RS component 198. In some aspects, the set of reference signals may be one of: a set of DMRS, a set of TRS, a set of PTRS, a set of CSI-RS, or a set of SRS.

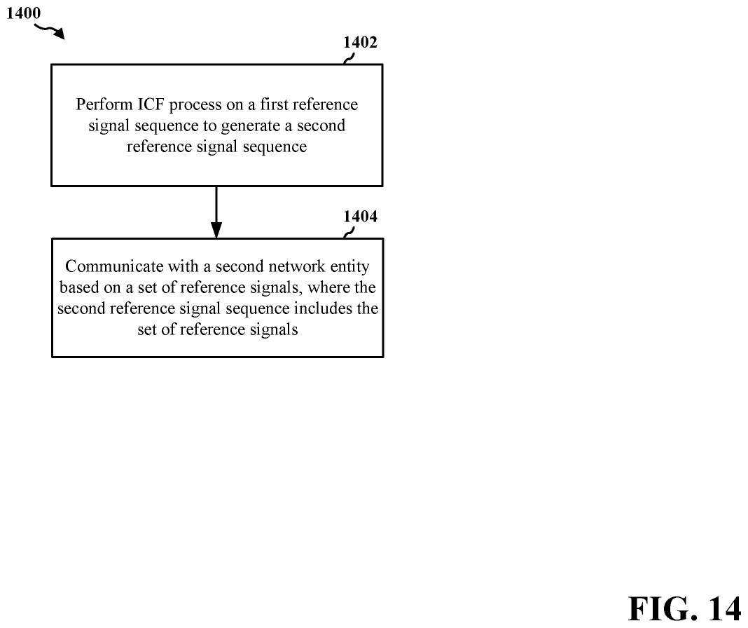

FIG. 14 is a flowchart 1400 of a method of wireless communication. The method may be performed by a first network entity (e.g., the UE 104, the base station 102, the UE 702, the network entity 704, the apparatus 1604, the network entity 1602, the network entity 1702).

At 1402, the first network entity may perform ICF process on a first reference signal sequence to generate a second reference signal sequence. For example, the first network entity (e.g., the UE 702 or the network entity 704) may perform ICF process on a first reference signal sequence to generate a second reference signal sequence at 710 or 712. In some aspects, 1402 may be performed by RS component 199.

At 1404, the first network entity may communicate with a second network entity based on a set of reference signals, where the second reference signal sequence includes the set of reference signals. For example, the first network entity (e.g., the UE 702 or the network entity 704) may communicate with a second network entity (e.g., 714) based on a set of reference signals, where the second reference signal sequence includes the set of reference signals. In some aspects, 1404 may be performed by RS component 199.

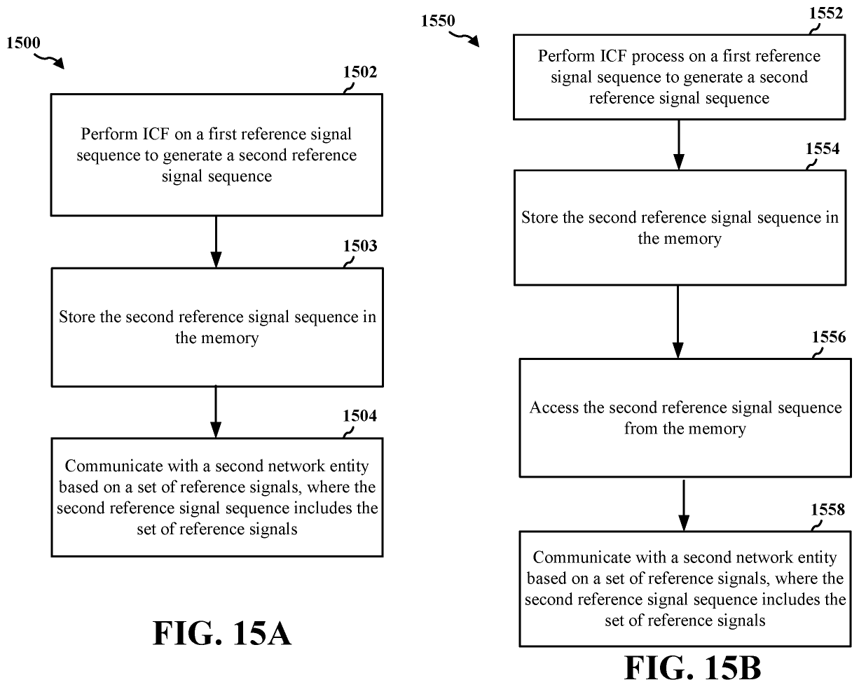

FIG. 15A is a flowchart 1500 of a method of wireless communication. The method may be performed by a first network entity (e.g., the UE 104, the base station 102, the UE 702, the network entity 704, the apparatus 1604, the network entity 1602, the network entity 1702).

At 1502, the first network entity may perform ICF on a first reference signal sequence to generate a second reference signal sequence. For example, the first network entity (e.g., the UE 702 or the network entity 704) may perform ICF process on a first reference signal sequence to generate a second reference signal sequence at 710 or 712. In some aspects. 1502 may be performed by RS component 199. In some aspects, to communicate with the second network entity based on the set of RSs at 1504, the first network entity may perform the digital ICF on the first RS sequence to generate the second reference signal sequence in real time (e.g., without storing the second reference signal sequence in a memory that stores data when there is no power present). In some aspects, to perform the digital ICF, the first network entity may access the first reference signal sequence from the memory. In some aspects, the digital ICF may include a low-pass filter, and where a first bandwidth associated with the low-pass filter may be equal to a second bandwidth associated with the second reference signal sequence. In some aspects, the digital ICF may include a clip associated with a PAPR target.

At 1503, the first network entity may store the first reference signal in a memory. For example, the first network entity (e.g., the UE 702 or the network entity 704) may store the first reference signal sequence in a memory after the first reference signal sequence is generated at 710 or 712. In some aspects, 1503 may be performed by RS component 199.

At 1504, the first network entity may communicate with a second network entity based on a set of reference signals, where the second reference signal sequence includes the set of reference signals. For example, the first network entity (e.g., the UE 702 or the network entity 704) may communicate with a second network entity (e.g., 714) based on a set of reference signals, where the second reference signal sequence includes the set of reference signals. In some aspects, 1504 may be performed by RS component 199. In some aspects, the set of reference signals may be one of: a set of DMRS, a set of TRS, a set of PTRS, a set of CSI-RS, or a set of SRS.

FIG. 15B is a flowchart 1550 of a method of wireless communication. The method may be performed by a first network entity (e.g., the UE 104, the base station 102, the UE 702, the network entity 704, the apparatus 1604, the network entity 1602, the network entity 1702).

At 1552, the first network entity may perform ICF process on a first reference signal sequence to generate a second reference signal sequence. For example, the first network entity (e.g., the UE 702 or the network entity 704) may perform ICF process on a first reference signal sequence to generate a second reference signal sequence at 710 or 712. In some aspects, 1552 may be performed by RS component 199. In some aspects, to communicate with the second network entity based on the set of RSs at 1504, the first network entity may perform the digital ICF process on the first RS sequence to generate the second reference signal sequence in real time (e.g., without storing the second reference signal sequence in a memory that stores data when there is no power present). In some aspects, the digital ICF process may include a low-pass filter, and where a first bandwidth associated with the low-pass filter may be equal to a second bandwidth associated with the second reference signal sequence. In some aspects, the digital ICF process may include a clip associated with a PAPR target.

At 1554, the first network entity may store the first reference signal in a memory. For example, the first network entity (e.g., the UE 702 or the network entity 704) may store the first reference signal sequence in a memory after the first reference signal sequence is generated at 710 or 712. In some aspects, 1554 may be performed by RS component 199.

At 1556, the first network entity may access the second reference signal sequence from the memory. For example, the first network entity may access the first reference signal sequence from the memory to communicate with a second network entity based on a set of reference signals at 1558. In some aspects. 1556 may be performed by RS component 199.

At 1558, the first network entity may communicate with a second network entity based on a set of reference signals, where the second reference signal sequence includes the set of reference signals. For example, the first network entity (e.g., the UE 702 or the network entity 704) may communicate with a second network entity (e.g., 714) based on a set of reference signals, where the second reference signal sequence includes the set of reference signals. In some aspects, 1558 may be performed by RS component 199. In some aspects, the set of reference signals may be one of: a set of DMRS, a set of TRS, a set of PTRS, a set of CSI-RS, or a set of SRS.

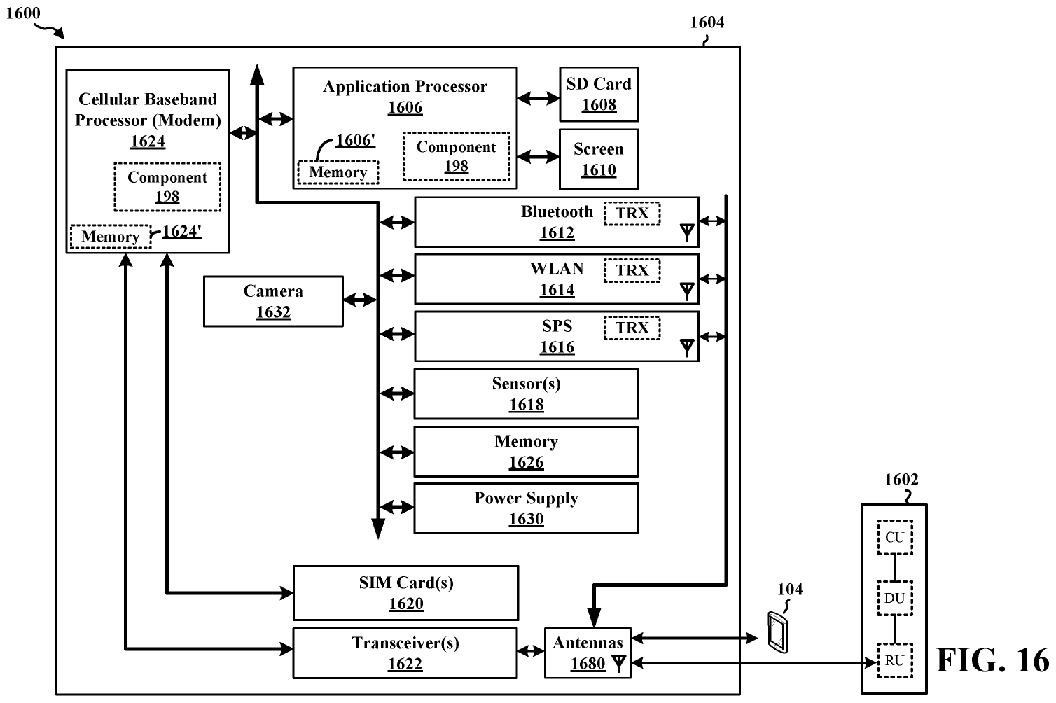

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, a satellite system module 1616 (e.g., GNSS module), one or more sensor modules 1618 (e.g., barometric pressure sensor/altimeter, motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the satellite system module 1616 may include an on-chip transceiver (TRX)/receiver (RX). The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described herein. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed herein, the RS component 198 may be configured to receive or transmit an indication associated with support of a first reference signal sequence, where the first reference signal is based on a second reference signal sequence via a digital ICF process. In some aspects, the RS component 198 may be further configured to communicate with a second network entity based on a set of reference signals, where the first reference signal sequence includes the set of reference signals. As discussed herein, the RS component 199 may be configured to perform ICF process on a first reference signal sequence to generate a second reference signal sequence. In some aspects, the RS component 199 or the RS component 198 may be further configured to communicate with a second network entity based on a set of reference signals, where the second reference signal sequence includes the set of reference signals. The RS component 198 or the RS component 199 may be within the cellular baseband processor 1624, the application processor 1606, or both the cellular baseband processor 1624 and the application processor 1606. The RS component 198 or the RS component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving or transmitting an indication associated with support of a first reference signal sequence, where the first reference signal is based on a second reference signal sequence via a digital ICF process. In some aspects, the apparatus 1604 may further include means for communicating with a second network entity based on a set of reference signals, where the first reference signal sequence includes the set of reference signals. In some aspects, the means for receiving or transmitting an indication may further include means for transmitting the indication to the second network entity via RRC signaling, DCI or UCI, or MAC-CE. In some aspects, the means for receiving or transmitting an indication may further include means for transmitting the indication to the second network entity via RRC signaling. DCI or UCI, or MAC-CE. In some aspects, the means for receiving or transmitting an indication may further include means for transmitting, to the second network entity via the RRC signaling or MAC-CE, one or more of: a LPF coefficient associated with the ICF process, a quantity of iterations associated with the ICF process, a PAPR target associated with the ICF process, a upscaling sampling factor associated with the ICF process or a downscaling sampling factor associated with the ICF process, a difference in PAPR between the first reference signal sequence and the second reference signal sequence, or an energy constraint threshold associated with the ICF process. In some aspects, the apparatus 1604 may include means for performing ICF process on a first reference signal sequence to generate a second reference signal sequence. In some aspects, the apparatus 1604 may include means for communicating with a second network entity based on a set of reference signals, where the second reference signal sequence includes the set of reference signals. In some aspects, the apparatus 1604 may include means for storing the first reference signal sequence in the memory, such as the memory 1624′, the memory 1606′, or the memory 1626. In some aspects, the network entity 1702 may include means for performing ICF on a first reference signal sequence to generate a second reference signal sequence. In some aspects, the network entity 1702 may include means for accessing the first reference signal sequence from the memory to perform the digital ICF. In some aspects, the network entity 1702 may include means for accessing the second reference signal sequence from the memory to communicate with the second network entity based on the set of reference signals. In some aspects, the network entity 1702 may include means for generating the second reference signal sequence in real time. In some aspects, the network entity 1702 may include means for accessing the second reference signal sequence to communicate with the second network entity. In some aspects, the apparatus 1604 may include means for transmitting one or more properties regarding the set of reference signals to a neighbor cell. The means may be the RS component 198 or the RS component 199 of the apparatus 1604 configured to perform the functions recited by the means. As described herein, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

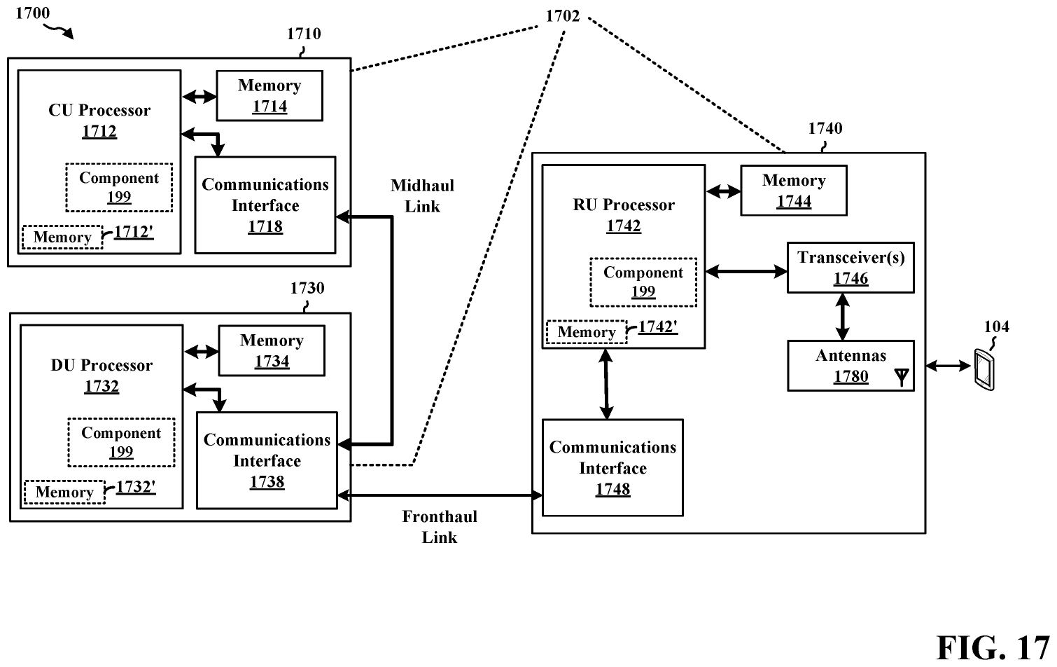

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740, the CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the RS component 198 may be configured to receive or transmit an indication associated with support of a first reference signal sequence, where the first reference signal is based on a second reference signal sequence via a digital ICF process. In some aspects, the RS component 198 may be further configured to communicate with a second network entity based on a set of reference signals, where the first reference signal sequence includes the set of reference signals. As discussed herein, the RS component 199 may be configured to perform ICF process on a first reference signal sequence to generate a second reference signal sequence. In some aspects, the RS component 199 or the RS component 198 may be further configured to communicate with a second network entity based on a set of reference signals, where the first reference signal sequence includes the set of reference signals. The RS component 199 or the RS component 198 may be within one or more processors of one or more of the CU 1710, DU 1730, and the RU 1740. The RS component 199 may be one or more hardware components specifically configured to carry out the stated processes/algorithm, implemented by one or more processors configured to perform the stated processes/algorithm, stored within a computer-readable medium for implementation by one or more processors, or some combination thereof. In one configuration, the network entity 1702 may include means for receiving or transmitting an indication associated with support of a first reference signal sequence, where the first reference signal is based on a second reference signal sequence via a digital ICF process. In some aspects, the network entity 1702 may further include means for communicating with a second network entity based on a set of reference signals, where the first reference signal sequence includes the set of reference signals. In some aspects, the means for receiving or transmitting an indication may further include means for transmitting the indication to the second network entity via RRC signaling, DCI or UCI, or MAC-CE. In some aspects, the means for receiving or transmitting an indication may further include means for transmitting the indication to the second network entity via RRC signaling, DCI or UCI, or MAC-CE. In some aspects, the means for receiving or transmitting an indication may further include means for transmitting, to the second network entity via the RRC signaling or MAC-CE, one or more of: a LPF coefficient associated with the ICF process, a quantity of iterations associated with the ICF process, a PAPR target associated with the ICF process, a upscaling sampling factor associated with the ICF process or a downscaling sampling factor associated with the ICF process, a difference in PAPR between the first reference signal sequence and the second reference signal sequence, or an energy constraint threshold associated with the ICF process. In some aspects, the network entity 1702 may include means for communicating with a second network entity based on a set of reference signals, where the second reference signal sequence includes the set of reference signals. In some aspects, the network entity 1702 may include means for storing the first reference signal sequence in the memory, such as the memory 1712, the memory 1732′, or the memory 1742′. In some aspects, the network entity 1702 may include means for performing ICF on a first reference signal sequence to generate a second reference signal sequence. In some aspects, the network entity 1702 may include means for accessing the first reference signal sequence from the memory to perform the digital ICF. In some aspects, the network entity 1702 may include means for accessing the second reference signal sequence from the memory to communicate with the second network entity based on the set of reference signals. In some aspects, the network entity 1702 may include means for generating the second reference signal sequence in real time. In some aspects, the network entity 1702 may include means for accessing the second reference signal sequence to communicate with the second network entity. In some aspects, the network entity 1702 may include means for transmitting one or more properties regarding the set of reference signals to a neighbor cell. The network entity 1702 may include a variety of components configured for various functions. The means may be the RS component 199 of the network entity 1702 configured to perform the functions recited by the means. As described herein, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory; and at least one processor coupled to the memory, where the at least one processor is configured to: receive or transmit an indication associated with support of a first reference signal sequence, where the first reference signal is based on a second reference signal sequence via a digital iterative clipping and filtering (ICF) process; and communicate with a second network entity based on a set of reference signals, where the first reference signal sequence includes the set of reference signals.

Aspect 2 is the first network entity of any of aspects 1, where the indication includes one or more of: low pass filter (LPF) coefficient information associated with the ICF process, quantity of iterations information associated with the ICF process, peak-to-average-power ratio (PAPR) target information associated with the ICF process, upscaling sampling factor information associated with the ICF process, downscaling sampling factor information associated with the ICF process, information regarding difference in PAPR between the first reference signal sequence and the second reference signal sequence, or energy constraint threshold information associated with the ICF process.

Aspect 3 is the first network entity of any of aspects 1-2, where the first network entity is a user equipment (UE) and the second network entity is a base station, where the indication is associated with a downlink transmission from the second network entity to the first network entity, and where, to receive or transmit the indication, the at least one processor is configured to: transmit the indication to the second network entity via radio resource control (RRC) signaling, a medium access control (MAC) control element (MAC-CE), or uplink control information (UCI).

Aspect 4 is the first network entity of any of aspects 1-2, where the first network entity is a base station and the second network entity is a user equipment (UE), where the indication is associated with a downlink transmission from the first network entity to the second network entity, and where to receive or transmit the indication, the at least one processor is configured to: transmit the indication to the second network entity via radio resource control (RRC) signaling, a medium access control (MAC) control element (MAC-CE), or downlink control information (DCI).

Aspect 5 is the first network entity of any of aspects 1-2, where the first network entity is a user equipment (UE) and the second network entity is a base station, where the indication is associated with an uplink transmission from the first network entity to the second network entity, and where to receive or transmit the indication, the at least one processor is configured to: transmit the indication to the second network entity via radio resource control (RRC) signaling, a medium access control (MAC) control element (MAC-CE), or uplink control information (UCI).

Aspect 6 is the first network entity of any of aspects 1-5, where: the LPF coefficient information includes a LPF coefficient, the quantity of iterations information includes a quantity of iterations, the PAPR target information includes a PAPR target, the upscaling sampling factor information includes a upscaling sampling factor, the downscaling sampling factor information includes a downscaling sampling factor, the information regarding the difference in the PAPR includes a PAPR difference, or the energy constraint threshold information includes an energy constraint threshold.

Aspect 7 is the first network entity of any of aspects 1-5, where the at least one processor is configured to: transmit, to the second network entity via RRC signaling, medium access control (MAC) control element (MAC-CE), or uplink control information (UCI), one or more of: a LPF coefficient associated with the ICF process, a quantity of iterations associated with the ICF process, a PAPR target associated with the ICF process, a upscaling sampling factor associated with the ICF process or a downscaling sampling factor associated with the ICF process, a difference in PAPR between the first reference signal sequence and the second reference signal sequence, or an energy constraint threshold associated with the ICF process.

Aspect 8 is the first network entity of any of aspects 1-2, where the first network entity is a base station and the second network entity is a user equipment (UE), where the indication is associated with an uplink transmission from the second network entity to the first network entity, and where to receive or transmit the indication, the at least one processor is configured to: transmit the indication to the second network entity via radio resource control (RRC) a medium access control (MAC) control element (MAC-CE), or downlink control information (DCI).

Aspect 9 is the first network entity of any of aspects 1-8, where the set of reference signals is one of: a set of demodulation reference signals, a set of tracking reference signals, a set of phase tracking signals, or a set of sounding reference signals.

Aspect 10 is the first network entity of any of aspects 1-9, where the digital ICF process includes a low-pass filter, and where a first bandwidth associated with the low-pass filter is equal to a second bandwidth associated with the second reference signal sequence.

Aspect 11 is the first network entity of any of aspects 1-10, where the digital ICF process includes a clip associated with a peak-to-average-power ratio (PAPR) target.

Aspect 12 is the first network entity of any of aspects 1-11, where the at least one processor is configured to: transmit one or more properties regarding the set of reference signals to a neighbor cell.

Aspect 13 is a first network entity for wireless communication, including: a memory; and at least one processor coupled to the memory, where the at least one processor is configured to: perform digital iterative clipping and filtering (ICF) on a first reference signal sequence to generate a second reference signal sequence; and communicate with a second network entity based on a set of reference signals, where the second reference signal sequence includes the set of reference signals.

Aspect 14 is the first network entity of aspect 13, where the first network entity is a user equipment (UE) and the second network entity is a base station, and where the at least one processor is configured to: store the second reference signal sequence in the memory.

Aspect 15 is the first network entity of aspect 13, where the first network entity is a user equipment (UE) and the second network entity is a base station, and where to communicate with the second network entity based on the set of reference signals, the at least one processor is configured to: perform the digital ICF on the first reference signal sequence to generate the second reference signal sequence in real time.

Aspect 16 is the first network entity of aspect 13, where the first network entity is a base station and the second network entity is a user equipment (UE), and where the at least one processor is configured to: store the second reference signal sequence in the memory.

Aspect 17 is the first network entity of aspect 13, where the first network entity is a base station and the second network entity is a user equipment (UE), and where to communicate with the second network entity based on the set of reference signals, the at least one processor is configured to: perform the digital ICF on the first reference signal sequence to generate the second reference signal sequence in real time.

Aspect 18 is the first network entity of any of aspects 13-17, where the set of reference signals is one of: a set of demodulation reference signals, a set of tracking reference signals, a set of phase tracking signals, or a set of sounding reference signals.

Aspect 19 is the first network entity of any of aspects 13-18, where the digital ICF includes a low-pass filter, and where a first bandwidth associated with the low-pass filter is equal to a second bandwidth associated with the first reference signal sequence.

Aspect 20 is the first network entity of any of aspects 13-19, where the digital ICF includes a clip associated with a peak-to-average-power ratio (PAPR) target.

Aspect 21 is the first network entity of any of aspects 13-20, where the at least one processor is configured to: transmit one or more properties regarding the set of reference signals to a neighbor cell.

Aspect 22 is the first network entity of any of aspects 13, where the memory has the first reference signal sequence stored thereon, and where, to perform the digital ICF, the at least one processor is configured to access the first reference signal sequence from the memory.

Aspect 23 is a first network entity for wireless communication, including: a memory having a first reference signal sequence and a second reference sequence signal stored thereon, where the second reference signal is based on the first reference signal sequence via a digital iterative clipping and filtering (ICF) process; and at least one processor coupled to the memory, where the at least one processor is configured to: communicate with a second network entity based on a set of reference signals, where the second reference signal sequence includes the set of reference signals.

Aspect 24 is the first network entity of aspect 23, where, to communicate with the second network entity based on the set of reference signals, the at least one processor is configured to access the second reference signal sequence from the memory.

Aspect 25 is the first network entity of any of aspects 23-24, where the at least one processor is configured to perform the digital ICF process to generate the second reference signal sequence based on the first reference signal sequence.

Aspect 26 is the first network entity of any of aspects 23-25, where the set of reference signals is one of: a set of demodulation reference signals, a set of tracking reference signals, a set of phase tracking signals, or a set of sounding reference signals.

Aspect 27 is the first network entity of any of aspects 23-26, where the digital ICF process includes a low-pass filter, and where a first bandwidth associated with the low-pass filter is equal to a second bandwidth associated with the second reference signal sequence.

Aspect 28 is the first network entity of any of aspects 23-27, where the digital ICF process includes a clip associated with a peak-to-average-power ratio (PAPR) target.

Aspect 29 is a method of wireless communication for implementing any of aspects 1 to 12.

Aspect 30 is an apparatus for wireless communication including means for implementing any of aspects 1 to 12.

Aspect 31 is a computer-readable medium (e.g., a non-transitory computer-readable medium) storing computer executable code, where the code when executed by a processor causes the processor to implement any of aspects 1 to 12.

Aspect 32 is a method of wireless communication for implementing any of aspects 13 to 22.

Aspect 33 is an apparatus for wireless communication including means for implementing any of aspects 13 to 22.

Aspect 34 is a computer-readable medium (e.g., a non-transitory computer-readable medium) storing computer executable code, where the code when executed by a processor causes the processor to implement any of aspects 13 to 22.

Aspect 35 is a method of wireless communication for implementing any of aspects 23 to 28.

Aspect 36 is an apparatus for wireless communication including means for implementing any of aspects 23 to 28.

Aspect 37 is a computer-readable medium (e.g., a non-transitory computer-readable medium) storing computer executable code, where the code when executed by a processor causes the processor to implement any of aspects 23 to 28.

1. A first network entity for wireless communication, comprising:
a memory; and
at least one processor coupled to the memory, wherein the at least one processor is configured to:
receive or transmit an indication associated with support of a first reference signal sequence, wherein the first reference signal is based on a second reference signal sequence via a digital iterative clipping and filtering (ICF) process; and
communicate with a second network entity based on a set of reference signals, wherein the first reference signal sequence includes the set of reference signals.

2. The first network entity of claim 1, wherein the indication comprises one or more of:
low pass filter (LPF) coefficient information associated with the ICF process,
quantity of iterations information associated with the ICF process,
peak-to-average-power ratio (PAPR) target information associated with the ICF process,
upscaling sampling factor information associated with the ICF process,
downscaling sampling factor information associated with the ICF process,
information regarding difference in PAPR between the first reference signal sequence and the second reference signal sequence, or
energy constraint threshold information associated with the ICF process.

3. The first network entity of claim 2, wherein the first network entity is a user equipment (UE) and the second network entity is a base station, wherein the indication is associated with a downlink transmission from the second network entity to the first network entity, and wherein, to receive or transmit the indication, the at least one processor is configured to:
transmit the indication to the second network entity via radio resource control (RRC) signaling, a medium access control (MAC) control element (MAC-CE), or uplink control information (UCI).

4. The first network entity of claim 2, wherein the first network entity is a base station and the second network entity is a user equipment (UE), wherein the indication is associated with a downlink transmission from the first network entity to the second network entity, and wherein to receive or transmit the indication, the at least one processor is configured to:
transmit the indication to the second network entity via radio resource control (RRC) signaling, a medium access control (MAC) control element (MAC-CE), or downlink control information (DCI).

5. The first network entity of claim 2, wherein the first network entity is a user equipment (UE) and the second network entity is a base station, wherein the indication is associated with an uplink transmission from the first network entity to the second network entity, and wherein to receive or transmit the indication, the at least one processor is configured to:
transmit the indication to the second network entity via radio resource control (RRC) signaling, a medium access control (MAC) control element (MAC-CE), or uplink control information (UCI).

6. The first network entity of claim 5, wherein:
the LPF coefficient information comprises a LPF coefficient,
the quantity of iterations information comprises a quantity of iterations,
the PAPR target information comprises a PAPR target,
the upscaling sampling factor information comprises a upscaling sampling factor,
the downscaling sampling factor information comprises a downscaling sampling factor,
the information regarding the difference in the PAPR comprises a PAPR difference, or
the energy constraint threshold information comprises an energy constraint threshold.

7. The first network entity of claim 5, wherein the at least one processor is configured to:
transmit, to the second network entity via RRC signaling, medium access control (MAC) control element (MAC-CE), or uplink control information (UCI), one or more of: a LPF coefficient associated with the ICF process, a quantity of iterations associated with the ICF process, a PAPR target associated with the ICF process, a upscaling sampling factor associated with the ICF process or a downscaling sampling factor associated with the ICF process, a difference in PAPR between the first reference signal sequence and the second reference signal sequence, or an energy constraint threshold associated with the ICF process.

8. The first network entity of claim 2, wherein the first network entity is a base station and the second network entity is a user equipment (UE), wherein the indication is associated with an uplink transmission from the second network entity to the first network entity, and wherein to receive or transmit the indication, the at least one processor is configured to:
transmit the indication to the second network entity via radio resource control (RRC) a medium access control (MAC) control element (MAC-CE), or downlink control information (DCI).

9. The first network entity of claim 1, wherein the set of reference signals is one of: a set of demodulation reference signals, a set of tracking reference signals, a set of phase tracking signals, or a set of sounding reference signals.

10. The first network entity of claim 1, wherein the digital ICF process comprises a low-pass filter, and wherein a first bandwidth associated with the low-pass filter is equal to a second bandwidth associated with the second reference signal sequence.

11. The first network entity of claim 1, wherein the digital ICF process comprises a clip associated with a peak-to-average-power ratio (PAPR) target.

12. The first network entity of claim 1, wherein the at least one processor is configured to: transmit one or more properties regarding the set of reference signals to a neighbor cell.

13. A first network entity for wireless communication, comprising:
a memory; and
at least one processor coupled to the memory, wherein the at least one processor is configured to:
perform digital iterative clipping and filtering (ICF) on a first reference signal sequence to generate a second reference signal sequence; and
communicate with a second network entity based on a set of reference signals, wherein the second reference signal sequence includes the set of reference signals.

14. The first network entity of claim 13, wherein the first network entity is a user equipment (UE) and the second network entity is a base station, and wherein the at least one processor is configured to:
store the second reference signal sequence in the memory.

15. The first network entity of claim 13, wherein the first network entity is a user equipment (UE) and the second network entity is a base station, and wherein to communicate with the second network entity based on the set of reference signals, the at least one processor is configured to: perform the digital ICF on the first reference signal sequence to generate the second reference signal sequence in real time.

16. The first network entity of claim 13, wherein the first network entity is a base station and the second network entity is a user equipment (UE), and wherein the at least one processor is configured to:
store the second reference signal sequence in the memory.

17. The first network entity of claim 13, wherein the first network entity is a base station and the second network entity is a user equipment (UE), and wherein to communicate with the second network entity based on the set of reference signals, the at least one processor is configured to: perform the digital ICF on the first reference signal sequence to generate the second reference signal sequence in real time.

18. The first network entity of claim 13, wherein the set of reference signals is one of: a set of demodulation reference signals, a set of tracking reference signals, a set of phase tracking signals, or a set of sounding reference signals.

19. The first network entity of claim 13, wherein the digital ICF comprises a low-pass filter, and wherein a first bandwidth associated with the low-pass filter is equal to a second bandwidth associated with the first reference signal sequence.

20. The first network entity of claim 13, wherein the digital ICF comprises a clip associated with a peak-to-average-power ratio (PAPR) target.

21-29. (canceled)
